(19) United States
(12) Patent Application Publication
(10) Pub. No.: US 2026/0285118 A1
(43) Pub. Date: Sep. 24, 2026

(54) RUNNING GEAR ASSEMBLY HAVING AN ADJUSTING DEVICE FOR A STABILIZER DEVICE

(71) Applicant: Vibracoustic SE, Weinheim (DE)

(72) Inventors: Ersan Altinoluk, Hamburg (DE); Dieter Bulling, Wedemark (DE)

(21) Appl. No.: 19/297,260

(22) Filed: Aug. 12, 2025

(30) Foreign Application Priority Data
Aug. 12, 2024 (DE) 10 2024 122 930.6

(51) Int. Cl. B60G 21/055; B60G 15/06

(52) U.S. Cl. CPC B60G 21/0551; B60G 15/068; B60G 2204/1224; B60G 2204/422

(57) ABSTRACT

A running gear assembly has a vibration damper unit with a longitudinal axis and comprises a damper, a spring surrounding at least part of the damper, and a counter mount, which may be arranged directly or indirectly on a vehicle frame, on which the damper is mounted and which forms a first spring abutment surface, against which the spring rests. The assembly has a stabilizer device, which comprises a stabilizer element, which may be mounted on the vehicle frame to be pivotable about a stabilizer pivot axis, a coupling element, which is mounted in an articulated manner on the stabilizer element a distance from the stabilizer pivot axis by a first end and is mounted in an articulated manner on the vibration damper unit by a second end. The coupling element may be mounted on an adjusting device for a movement relative to the damper in an axial adjustment direction.

### CROSS-REFERENCE TO RELATED APPLICATION

This application claims priority to German Patent Application No. DE 10 2024 122 930.6, filed on Aug. 12, 2024, the content of which is hereby incorporated in its entirety.

### TECHNICAL FIELD

The invention relates to a running gear assembly. The running gear assembly has at least one vibration damper unit and a stabilizer device. A longitudinal axis extends through the vibration damper unit. The vibration damper unit comprises a damper, a spring surrounding at least part of the damper, and a counter mount, which is to be arranged directly or indirectly on a vehicle frame. The damper is mounted on the counter mount. The counter mount forms a first spring abutment surface, against which the spring rests. The stabilizer device comprises a stabilizer element, which is to be mounted on the vehicle frame so as to be pivotable about a stabilizer pivot axis, and at least one coupling element. The coupling element is mounted in an articulated manner on the stabilizer element at a distance from the stabilizer pivot axis by means of a first end and is mounted in an articulated manner on the vibration damper unit by means of a second end.

### BACKGROUND

A running gear assembly of this kind is known from the prior art. In use, the running gear assembly is used, in particular, to form a MacPherson running gear assembly. In the known running gear assembly, the coupling element is mounted in an articulated manner on a damper tube of the damper by means of the second end. During the use of the running gear assembly, the second end of the coupling element is therefore in a fixed location with respect to an axis of rotation of a wheel of the running gear.

The stabilizer device is a device which is used to reduce the roll angle which arises during cornering. The stabilizer element typically counteracts differential inward deflection of the front wheels inasmuch as it is associated with torsion of the stabilizer element. Moreover, to create the possibility of torsion, the stabilizer element is mounted on the vehicle frame during use by means of an elastic stabilizer mount that permits a pivoting movement about the stabilizer pivot axis.

From this form of mounting of the coupling element on the vibration damper unit, on the one hand, and the mounting of the stabilizer element on the vehicle frame, on the other hand, it necessarily follows that, irrespective of the torsion of the stabilizer element, each change in height of the vehicle frame, in particular each quasi static change in height of the vehicle frame, which is associated, for example, with people getting in and out, with a change in the state of loading of the vehicle or else, in the case of an electric vehicle, with an adaptation of the ground clearance to regulate battery cooling by means of the air flow along the floor of the vehicle, is associated with at least partial pivoting of the stabilizer element about the stabilizer pivot axis. Each pivoting action, in turn, involves shear loading of the elastic stabilizer mount. The known running gear assembly is disadvantageous on account of particularly large shear loads, which are made up of the quasi static change in height and dynamic changes in height that occur during driving and which can lead in the unfavorable case to premature failure of the stabilizer mount.

### SUMMARY

It is an object of the invention to provide a more developed running gear assembly, by means of which it is possible to reduce the probability of failure of the stabilizer mount. It is another object of the invention to provide a more reliable vehicle that has the more developed running gear assembly.

In accordance with aspects and teachings of the disclosure, the running gear assembly may be firstly constructed in such a way that the coupling element is mounted by means of its second end on an adjusting device, which is designed for a movement of the coupling element relative to the damper in an at least partially axial adjustment direction. The adjusting device may be surrounded by the vibration damper unit. By means of the adjusting device, the fixed-location arrangement of the second end of the coupling element relative to the axis of rotation is canceled, and it is possible to actively exert an influence on the pivoting of the stabilizer element about the stabilizer pivot axis and, in particular, on the torsion of the stabilizer element. Pivoting, whichmay be caused by a quasi static change in height of the vehicle frame, can be compensated by the adjusting device. As a result, the loading on the mounts between the vehicle frame and the stabilizer element can be considerably reduced. This in turn considerably reduces the probability of failure of the stabilizer mount and thus of the running gear assembly.

The vibration damper unit may be designed as a spring strut. The vibration damper unit may be designed as a MacPherson strut, which is characteristically designed, above and beyond the pure spring and damper effect, to absorb forces exerted on the vibration damper unit by the wheel during use. In this case, the spring extends, in particular, in a spiral around a spring longitudinal axis, which is preferably aligned at an angle to the above-described longitudinal axis of the vibration damper unit and, in particular, of the damper. By virtue of the angling of the spring longitudinal axis with respect to the longitudinal axis, the spring is of optimum design for the absorption of said forces and for good axle kinematics.

The damper may comprises a damper rod and a damper tube, which are movable relative to one another, preferably in the adjustment direction. The damper rod is preferably arranged on the counter mount. The damper tube is preferably to be arranged or is arranged on a wheel carrier. The damper may comprise a cover placed on a damper tube end facing the counter mount. At least part of the damper rod may be surrounded by an additional spring resting, such as, against the counter mount.

The counter mount may be used to mount the vibration damper unit on the vehicle frame, such as on a vehicle chassis. The counter mount is commonly referred to as a “top mount”. The counter mount is preferably of multi-part design. As a particular preference, it may comprise at least one elastic mount part and/or rolling bearing to absorb axial and radial forces with a simultaneous degree of torsional freedom. The counter mount may be designed such that at least the first spring abutment surface is designed to be rotatable, such as about the longitudinal axis, relative to a counter mount attachment surface that faces away from the first spring abutment surface and is to be placed against the vehicle chassis. It is also possible for rotational decoupling to be performed at a different location of the vibration damper unit, with said unit being integrated into the adjusting device, for example.

The adjusting device may be arranged at least partially on the damper, preferably on the damper tube. The adjusting device is preferably constructed in such a way that the adjustment direction is aligned (exclusively) axially and thus parallel to the longitudinal axis. The adjusting device is designed, in particular, for a movement of the coupling element, which movement is triggered or to be triggered independently of a movement of the damper or of the damper tube relative to the vehicle frame or to some other component of the running gear assembly. The adjusting device may allow an arbitrary movement of the coupling element and/or an automatic movement as a function of the actual and/or desired height of the vehicle frame, such as by means of axial movement of a connecting element to be described in greater detail below relative to the wheel carrier. The movement may take place at least relative to the damper and/or the counter mount and/or the wheel carrier of the vibration damper unit.

The adjusting device may have a control unit for controlling the movement of the coupling element. Here, control may be exercised without direct mechanical dependence of the position of the coupling element on the position of another component of the running gear assembly. As an alternative to the control unit, the adjusting device may also be of purely mechanical design.

The stabilizer element may be substantially U-shaped and, may be of an integral design. The stabilizer element is also referred to as a stabilizer rod. The coupling element may form ball joints and/or elastomer mounts at both ends. The coupling element may be referred to as a stabilizer coupling rod. The first end may be situated opposite the second end.

The adjusting device may preferably comprise at least one first adjustment partner and at least one second adjustment partner. The first adjustment partner may be arranged in a fixed location with respect to at least part of the damper, in particular with respect to the damper housing. The second adjustment partner may be movable relative to the first adjustment partner in the adjustment direction. The coupling element may be mounted on the second adjustment partner. During the use of the running gear assembly, the first adjustment partner may be arranged so as to rest, for example, against the wheel carrier. This two-part construction of the adjusting device can enable it the adjusting device to be made particularly reliable.

The adjusting device may form a variable-size fluid chamber between the first adjustment partner and the second adjustment partner. The fluid chamber may be designed to hold a gas or a liquid, which is to be used to expand the fluid chamber. Variation of the size of the fluid chamber preferably necessarily entails a movement of the coupling element in the adjustment direction or counter to the adjustment direction. The adjusting device preferably has at least one valve for filling and/or emptying the fluid chamber. The first adjustment partner and/or the second adjustment partner surround/surrounds the longitudinal axis, preferably completely. In terms of construction, therefore, recourse should be had to adjusting devices that are fundamentally tried and tested in the vehicle sector.

The adjusting device preferably has at least one rolling bellows to form the fluid chamber. The rolling bellows is secured on the first adjustment partner and on the second adjustment partner. The rolling bellows may form at least one rolling fold. As a result, the variable-size fluid chamber is of structurally simple and reliable design. In use, the rolling bellows unrolls as the fluid chamber is filled, and the rolling bellows rolls up as the fluid chamber is emptied. As an alternative to the rolling bellows with a rolling fold, it is possible to use a fluid cushion.

The adjusting device may be designed in such a way that the fluid chamber is formed with an offset in the adjustment direction with respect to the second end of the coupling element. This may apply in each position of the adjusting device. This means that the fluid chamber is arranged completely on one side of a plane at right angles to the longitudinal direction and that the second end is arranged on the other side of this plane. The adjusting device, i.e., the second adjustment partner, preferably has the/a connecting element which projects radially from the longitudinal axis and on which the second end of the coupling element is secured in an articulated manner. As a particular preference, the connecting element as a whole may be arranged on the other side of said plane. This ensures that the second end of the coupling element can have a preferred proximity to the longitudinal axis, despite the fluid chamber. As a result, the optimized effect of the stabilizer device may be unaffected during use.

Irrespective of the above-described arrangement of the connecting element of the second adjustment partner, the connecting element is preferably designed in such a way for the mounting of the second end of the coupling element that a first distance between the second end of the coupling element and the longitudinal axis is smaller than a second distance between an outer surface, facing away from the longitudinal axis, of the second adjustment partner and the longitudinal axis. A straight line which is parallel to the longitudinal axis and which touches the outer surface of the second adjustment partner preferably intersects the second end of the coupling element and/or the connecting element. As a result, dimensioning of the adjusting device to achieve adequate forces for the movement of the coupling element is made possible.

The second adjustment partner preferably has a tubular bridging element. As a particular preference, the coupling element is arranged thereon directly or by means of the connecting element. As an alternative or in addition to the bridging element, the second adjustment element has, at its end facing the first adjustment partner, a force absorption element whichmay project radially from the bridging element and which may have the abovementioned outer surface. The force absorption element may be in the form of a flange or a perforated disk. The connecting element may be arranged between the force absorption element and the spring.

The adjusting device is preferably designed as a foot point adjusting device. This means that the adjusting device is designed for changing the position of at least part of the spring, such as relative to the counter mount and/or to the damper housing. Said part of the spring may be, in particular, that end of the spring which faces away from the counter mount. The adjusting device may be designed in such a way that a distance, measured in the adjustment direction, between that end of the spring which faces away from the counter mount and the second end of the coupling element remains constant, while the distance between the connecting element and the wheel carrier can be adjusted. An end of the second adjustment partner which faces away from the first adjustment partner is formed, for example, by a radially projecting spring abutment element which forms a second spring abutment surface, against which the spring rests and which may form a spring plate. The spring abutment element may be in the form of a flange or a perforated disk. The spring abutment element may be connected rigidly to the connecting element by means of the second spring abutment surface, against which the spring may rest with nonpositive and/or positive engagement. The spring abutment element may be designed in such a way that an outer surface of the spring abutment element which faces away from the longitudinal axis is further away from the longitudinal axis than the second end of the coupling element.

By virtue of the design of the adjusting device as a foot point adjusting device, the adjusting device combines two functions. On the one hand, the adjusting device can be used to protect the elastic stabilizer mount by reducing the shear loads generated by the quasi static changes in height, and to exert an influence on the torsion of the stabilizer element in order to change the stabilizing effect, particularly during the dynamic changes in height. On the other hand, the adjusting device can be used to change the height of the vehicle frame above the ground, e.g. in order to vary the aerodynamics or the cooling effect. The combination ensures that the change in height is possible completely or largely without imposing a load on the stabilizer mount.

Apart from the vibration damper unit, the running gear assembly preferably comprises the wheel carrier, a wheel hub, which is mounted on the wheel carrier in such a way as to be rotatable about an axis of rotation, and the wheel arranged on the wheel hub. The wheel has a wheel rim, which comprises a rim ring extending in a rotationally symmetrical manner around the axis of rotation. In this embodiment of the invention, an end of the damper facing away from the counter mount is arranged on the wheel carrier. The coupling element is arranged in such a way that the longitudinal axis extends through between the second end of the coupling element and at least part of the rim ring. By virtue of this construction, the customary and reliable attachment of the stabilizer device may be achieved, despite the adjusting device, such as the foot point adjusting device. The running gear assembly may be formed in mirror symmetry with respect to a central longitudinal axis, which is aligned at right angles to the stabilizer pivot axis.

Secondly, a vehicle may be provided to achieve an object of the disclosure. The vehicle may have a vehicle frame and a running gear assembly such as described above. The vehicle may comprise at least one mount element, which surrounds the stabilizer element and is secured on the stabilizer element. The mount element may be used for pivoting the stabilizer element about the stabilizer pivot axis. The mount element may be arranged between the stabilizer element and the vehicle frame and/or may be formed from an elastically deformable material, such as plastic. The vehicle may comprise at least one mount clamp element arranged in a fixed location on the vehicle frame. The mount clamp element may have an aperture which is a through aperture in the direction of the stabilizer pivot axis and in which the stabilizer element is arranged. The stabilizer element may be arranged in the aperture in such a way that the mount element is arranged between the mount clamp element and the stabilizer element. The mount element and the mount clamp element may together form the elastic stabilizer mount. With this construction, pivoting of the stabilizer element relative to the vehicle frame is associated, such as, with shear loading of the mount element, in particular with strain occurring in the elastomer thereof, which is to be reduced by means of the adjusting device, thereby enabling the life of the mount element to be extended.

The counter mount, such as the mount clamp element, may be arranged on the vehicle frame. The counter mount may rest by means of the attachment surface against the vehicle frame. Arrangement of the counter mount on the vehicle frame refers to fixed-location arrangement of at least part of the counter mount on the vehicle frame. This part should be understood to be arranged in a fixed location relative to the mount clamp element or to some other part of the elastic stabilizer mount inasmuch as no active movement of the two parts relative to one another is intended.

In detail, the vehicle preferably has two mount elements and mount clamp elements in each case. As a particular preference, the at least one mount clamp element may be screwed to the vehicle frame. The at least one mount element is preferably bonded, vulcanized and/or clamped to the stabilizer element and/or is formed from an elastomer.

### BRIEF DESCRIPTION OF THE DRAWINGS

Further details and advantages can be found in the schematically illustrated figure described below, where:

FIG. 1 generally illustrates a running gear assembly according to the aspects and teachings of the invention.

### DETAILED DESCRIPTION

The disclosures contained in the description as a whole can be applied mutatis mutandis to identical parts with identical reference signs or identical component designations. Moreover, the position indications chosen in the description refer to the figure described. The features described below can also form the subject matter of the invention in some combination other than that directly described or shown.

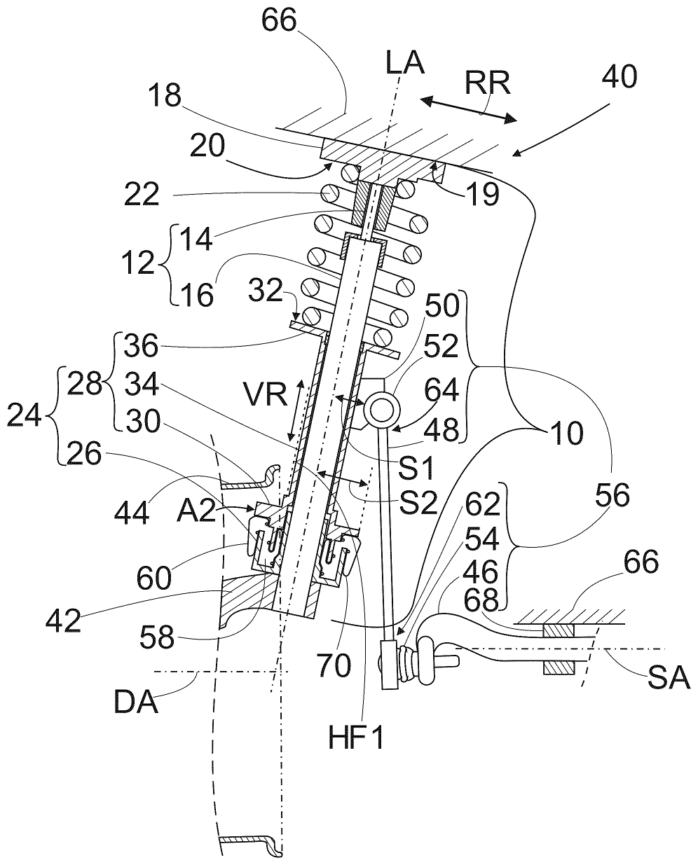

FIG. 1 generally illustrates a running gear assembly 40 comprising a vibration damper unit 10. A longitudinal axis LA extends through the vibration damper unit 10. The vibration damper unit 10 comprises a damper 12, which has a damper rod 14 and a damper tube 16. In addition, the vibration damper unit 10 has a spring 22, which surrounds part of the damper 12.

An upper end of the spring 22 is arranged on a first spring abutment surface 20 of a counter mount 18. In FIG. 1, the counter mount 18 is illustrated in a considerably simplified form and is shown schematically as a single part, despite having a construction which is in fact more complex. The counter mount 18 rests by means of an attachment surface 19 against a vehicle frame 66. The damper 12 is arranged on the counter mount 18 by means of the damper rod 14.

The damper tube 16 is arranged on a wheel carrier 42 by means of its end facing away from the counter mount 18. A wheel hub (not illustrated) is arranged on the wheel carrier 42 in such a way as to be rotatable relative to the wheel carrier 42 about an axis of rotation DA. A wheel with a rim which has a rim ring 14 that is illustrated in part is secured on the wheel hub.

An adjusting device 24 is arranged between the spring 22 and the wheel carrier 42. The adjusting device 24 has a first adjustment partner 26, which rests against the wheel carrier 42 and is arranged in a fixed location with respect to the damper tube 16. In addition, the adjusting device 24 has a second adjustment partner 28, which is movable relative to the first adjustment partner 26 in an adjustment direction VR. The adjustment direction VR is aligned parallel to the longitudinal axis LA.

The second adjustment partner 28 comprises a force absorption element 30, a bridging element 34 and a spring abutment element 36. The force absorption element 30 forms an end of the second adjustment partner 28 which faces the first adjustment partner 26, and it extends in the form of a flange. The bridging element 34 extends in the form of a tube around the longitudinal axis LA from the force absorption element 30 toward the counter mount 18 as far as the spring abutment element 36. The spring abutment element 36 forms a second spring abutment surface 32 for the spring 22 and, once again, extends in the form of a flange.

The adjusting device 24 forms a fluid chamber 58 between the first adjustment partner 26 and the second adjustment partner 28. For this purpose, the adjusting device 24 has a rolling bellows 60, which extends from the first adjustment partner 26 to the second adjustment partner 28.

In addition to the vibration damper unit 10, the running gear assembly 40 has a stabilizer device 56. The stabilizer device 56 essentially comprises a stabilizer element 46 and at least one coupling element 48. The stabilizer element 46 is of U-shaped and mirror-symmetrical design. The stabilizer element 46 is mounted on the vehicle frame 66 by means of an elastic stabilizer mount 68 in such a way as to be pivotable about a stabilizer pivot axis SA. The coupling element 48 has a first end 62 and a second end 64. The coupling element 48 is connected by means of a first coupling joint 52 to a connecting element 50, which is arranged on the bridging element 34. The coupling element 48 is connected to the stabilizer element 46 by means of a second coupling joint 54.

A first distance S1 between the second end 64 of the coupling element 48 and the longitudinal axis LA is less than a second distance S2 between an outer surface A2, facing away from the longitudinal axis LA, of the force absorption element 30 and the longitudinal axis LA. In this case, the two distances S1, S2 are measured in a radial direction RR with respect to the longitudinal axis LA. An auxiliary surface HF1 in which an outer surface of the bridging element 34 is situated intersects both the force absorption element 30 and the spring abutment element 36.

1. A running gear assembly having at least one vibration damper unit, through which a longitudinal axis extends and which comprises a damper, a spring surrounding at least part of the damper, and a counter mount, which is to be arranged directly or indirectly on a vehicle frame, on which the damper is mounted and which forms a first spring abutment surface, against which the spring rests, and having a stabilizer device, comprising a stabilizer element (46), which is to be mounted on the vehicle frame so as to be pivotable about a stabilizer pivot axis, and at least one coupling element, which is mounted in an articulated manner on the stabilizer element at a distance from the stabilizer pivot axis by means of a first end and is mounted in an articulated manner on the vibration damper unit by means of a second end,
wherein
the coupling element is mounted on an adjusting device configured for a movement of the coupling element relative to the damper in an at least partially axial adjustment direction.

2. The running gear assembly as claimed in claim 1, wherein the adjusting device comprises a first adjustment partner, which is arranged in a fixed location with respect to at least part of the damper, and a second adjustment partner, which is movable relative to the first adjustment partner in the adjustment direction and on which the coupling element is mounted.

3. The running gear assembly as claimed in claim 2, wherein the adjusting device forms a variable-size fluid chamber between the first adjustment partner and the second adjustment partner.

4. The running gear assembly as claimed in claim 3, wherein, to form the fluid chamber, the adjusting device has at least one rolling bellow, which is secured on the first adjustment partner and on the second adjustment partner.

5. The running gear assembly as claimed in claim 3, wherein the fluid chamber is formed with an offset in the adjustment direction with respect to the second end of the coupling element.

6. The running gear assembly as claimed in claim 2, wherein the second adjustment partner has a connecting element, on which the second end of the coupling element is mounted and which is configured such that a first distance between the second end of the coupling element and the longitudinal axis is smaller than a second distance between an outer surface, facing away from the longitudinal axis, of the second adjustment partner and the longitudinal axis.

7. The running gear assembly as claimed in claim 6, wherein the second adjustment partner comprises a tubular bridging element, on which the connecting element is arranged, and a force absorption element, which projects radially from an end of the bridging element that faces the first adjustment partner (26) and which has the outer surface.

8. The running gear assembly as claimed in claim 2, wherein the adjusting device is configured as a foot point adjusting device, and the second adjustment partner has, between the second end of the coupling element and the counter mount, a spring abutment element having a second spring abutment surface, against which the spring rests with nonpositive and/or positive engagement.

9. The running gear assembly as claimed in claim 1, which comprises a wheel carrier, a wheel hub, which is mounted on the wheel carrier in such a way as to be rotatable about an axis of rotation, a wheel, which is arranged on the wheel hub and comprises a wheel rim that has a rim ring extending in a rotationally symmetrical manner around the axis of rotation, wherein an end of the damper which faces away from the counter mount is arranged on the wheel carrier, and the coupling element is arranged in such a way that the longitudinal axis extends through between the second end of the coupling element and at least part of the rim ring.

10. A vehicle having a vehicle frame and a running gear assembly as claimed in claim 1, which comprises at least one mount element, which surrounds the stabilizer element, is secured on the stabilizer element and is elastically deformable to allow pivoting of the stabilizer element about the stabilizer pivot axis, and at least one mount clamp element, which is arranged in a fixed location on the vehicle frame, on which frame the counter mount is arranged in a fixed location, and which has an aperture which is a through aperture in the direction of the stabilizer pivot axis and in which the stabilizer element is arranged in such a way that the mount element is arranged between the mount clamp element and the stabilizer element.
